(19) United States
(12) Patent Application Publication
(10) Pub. No.: US 2021/0199389 A1
(43) Pub. Date: Jul. 1, 2021

(54) Container for recovering the heat energy of wastewater

(71) Applicant: Ecopa| Oy, Lahti (FI)

(72) Inventors: Jouni Helppolainen, Lahti (FI); Aarni Tervonen, Kokkola (FI)

(73) Assignee: Ecopa| Oy, Lahti (FI)

(21) Appl. No.: 16/761,822

(22) PCT Filed: Nov. 6, 2018
(86) PCT No.: PCT/FI2018/050810

§ 371 Date: May 6, 2020

(30) Foreign Application Priority Data
Nov. 6, 2017 (FI) 20175983

(51) Int. Cl. F28D 21/00; F28F 21/08; F28F 19/06; F28D 7/02; F28D 20/00

(52) U.S. Cl. CPC F28D 21/0012; F28F 21/083; F28D 20/0034; F28D 7/022; F28F 19/06

(57) ABSTRACT

The invention relates to a container (1) for recovering the heat energy of wastewater. The container (1) comprises a shell (10) and a continuous spiral pipe (2) for conveying wastewater through the container in a vertical direction. A first heat transfer space for a heat transfer liquid is arranged between an outer shell of the spiral pipe (2) and the shell (10) of the container (1), and a second heat transfer space is arranged inside the spiral pipe (2). The shell (10) is provided with at least one openable inspection hatch (6) having fastened thereto a manifold (7) as well as a shell and tube heat exchanger (3) having its inlet and outlet ends coupled to said manifold (7). The spiral pipe (2) consists of acid-proof or stainless steel and its internal surface is adapted to have a higher chromium content than the other parts of the spiral pipe's wall.

The invention relates to a container according to the preamble of claim 1 for recovering the heat energy of wastewater.

In view of recovering heat energy from municipal wastewaters, particularly residential wastewaters, there are prior known recovery systems, wherein the recovery system comprises a shell and tube heat exchanger made up of a tube side (primary side) and a shell side (secondary side) enclosing the former, said shell side carrying a heat transfer fluid. The tube side of a shell and tube exchanger in some shell and tube heat exchanger models is given a spiral design for ensuring a good heat transfer area and thereby heat transfer coefficient. These shell and tube heat exchangers with a spiral tube side nevertheless involve several problems if intended for use in the recovery of thermal energy from dirty domestic wastewaters (so-called blackwater) and contaminated municipal wastewater.

Typically, such wastewater heat energy recovery systems, wherein the heat energy of wastewater is recovered into a heat transfer fluid with a shell and tube heat exchanger of the above-described type, have namely been limited to the recovery of heat energy contained in just one type of wastewater, i.e. predominantly in residential greywater, and, on the other hand, the recovered heat energy has been most commonly used only for the heating of domestic hot water.

At present there are no heat exchanger assemblies commercially available, which would enable a single shell and tube heat exchanger with a preferably spiral tube side (spiral pipe) to be used for contaminated municipal wastewaters or domestic wastewater, especially blackwater, in order to recover the heat energy in such a way that the heating or cooling energy of wastewater could also be conducted to an optionally non-pressurized or pressurized heat transfer fluid which is flowing in the shell side of such a shell and tube heat exchanger.

This is firstly due to the fact that the recovery of energy for example from dirty blackwater flowing inside the spiral pipe of a shell and tube heat exchanger may cause problems as a result of clogged heat exchanger tubes. If an effort is made to prevent a spiral pipe clogging by replacing the spiral pipe on the tube side of a shell and tube heat exchanger with a straight pipe, this will result, on the other hand, in a significantly deteriorated heat transfer coefficient for the shell and tube heat exchanger as the heat transfer area diminishes and dwell time in the heat exchanger becomes shorter.

Accordingly, the preliminary prevention of a shell and tube heat exchanger contamination and convenience in the maintenance of a contaminated shell and tube heat exchanger are among the most important aspects in the treatment of dirty wastewaters, especially blackwater, with a spiral ductwork-equipped shell and tube heat exchanger, and in an effort to supply also the shell side with various heat transfer fluids. The prior art has failed to provide a satisfactory solution to this particular problem.

Moreover, if the tube side of such a spiral pipe-comprising shell and tube heat exchanger is to be supplied with wastewaters possibly containing significant amounts of various chemicals (i.a. wastewaters from indoor swimming pools), this will easily lead to corrosion problems which reduce remarkably the service life of a heat exchanger's tube side because of water-borne chemicals such as chlorine.

On the other hand, if a variety of heat transfer fluids to be supplied into the shell side is to be expanded, into which transfer fluids the heating or cooling effect of wastewater flowing in the tube side of a shell and tube heat exchanger is transferable, problems may ensue in terms of dimensioning the tube and shell sides of a heat exchanger assembly's shell and tube heat exchanger. The reason for this is that, when the energy recovery system is installed in an apartment building, it is particularly the tube side of such a shell and tube heat exchanger which must be dimensioned to withstand high pressures and/or pressure fluctuations.

This dimensioning problem can be at least partially solved by replacing the shell and tube heat exchanger with a spiral heat exchanger, wherein a heat transfer fluid is conveyed in its designated spiral pipe alongside a spiral wastewater pipe. In this case, however, the overall heat transfer coefficient decreases significantly when compared to using a shell and tube heat exchanger in which the shellside heat transfer fluid would directly surround a spiral pipe inside which flows the wastewater.

The problem caused by pressurized wastewaters can be solved by dimensioning the tube and shell sides of a shell and tube heat exchanger on the basis of a maximum pressure which the heat exchanger's tube side is designed to withstand. However, this may result in excessively thick wall structures particularly on the shell and tube heat exchanger's shell side and thereby in a reduced heat transfer coefficient.

Still another problem generally with heat exchanger assemblies equipped with a shell and tube heat exchanger and designed for recovering the energy of municipal wastewaters and residential wastewaters is the fact that the flow of wastewater into the recovery system and thereby into the shell and tube heat exchanger's primary side can be quite pulsating. Therefore, in heat exchanger assemblies intended for recovering wastewater energy, it has been necessary to accompany the heat exchangers with technically complicated flowing and pumping arrangements in an effort to equalize the flow of wastewater in the heat exchanger's primary side, especially in winter.

A container of the invention for recovering wastewater heat energy is intended for solving the problems appearing in the foregoing prior art.

Hence, it is a principal objective of the invention to provide a container made up of a shell and tube heat exchanger for recovering wastewater heat energy from domestic blackwaters and dirty municipal waters flowing on the shell and tube heat exchanger's tube side consisting of a spiral pipe into a heat transfer fluid surrounding the spiral pipe onto the shell and tube heat exchanger's shell side.

The foregoing principal objective is to be attained by constructing the container with adequate elements for preventing in advance the contamination of a shell and tube heat exchanger and for cleaning a contaminated shell and tube heat exchanger.

Another objective of the invention is to achieve structures as light as possible on a heat exchanger's tube side, as well as shell side, yet without making compromises that would jeopardize the heat exchanger's overall pressure resistance.

It is a further objective to provide a shell and tube heat exchanger, wherein the heat energy of wastewater flowing in a spiral pipe could be recovered into domestic water flowing inside the container without any possibility of the domestic water and the wastewater mixing with each other as the wastewater is made up of so-called black water.

The invention is further intended for keeping a shell and tube heat exchanger's tube side and shell side structurally as simple as possible. It is particular objective to maintain such a structure of the heat exchanger that it would not include electrical flowing and pumping arrangements used for regulating flow specifically on the heat exchanger's tube side.

A second starting point for design is such a capability that the heating or cooling energy of wastewater flowing inside a spiral pipe in a container made up of a shell and tube heat exchanger can be transferred into a possibly pressurized heat transfer fluid flowing on the heat exchanger's shell side. The heat transfer fluid should be selectable from among various heat transfer fluids capable of being heated or cooled, such as a primary side geothermal heat transfer fluid and a ventilation heat transfer fluid.

In this disclosure, the shell and tube heat exchanger's shell side (i.e. secondary side) refers to a first heat transfer space, which is defined between the container shell and the outer shell of a spiral pipe, and in which the heat transfer fluid is flowing. The energy of wastewater flowing in a spiral pipe present on the shell and tube heat exchanger's tube side or primary side is recovered into the heat transfer fluid flowing on the shell side.

The recovery of wastewater heat energy refers in this context to recovering both the heating energy and the cooling energy of wastewater, depending on whether the wastewater flowing on the heat exchanger's tube side is at a temperature higher or lower than a heat transfer fluid of the shell side.

The wastewater refers in this disclosure to a disposable water-based liquid having been used for municipal or residential service. The wastewater to be treated in a shell and tube heat exchanger comprises specifically black water.

It is with a container of claim 1 that the foregoing objectives are attained.

More specifically, the invention relates to a container of claim 1 for recovering the heat energy of wastewater. The container comprises a shell defining the container outwards, a continuous spiral pipe for conveying wastewater through the container in vertical direction. The spiral pipe is in communication with an extra-container wastewater ingress conduit by way of an inlet connection associated with the container shell, and with an extra-container wastewater egress conduit by way of an outlet connection associated with the container shell. The container further comprises a first heat transfer space encircling the spiral pipe and being confined by an outer shell of said spiral pipe and by the shell of the container, and said first heat transfer space being in communication with a heat transfer fluid ingress conduit by way of at least one heat transfer fluid inlet connection associated with the shell of the container, and with a heat transfer fluid egress conduit by way of at least one heat transfer fluid outlet connection associated with the shell of the container, as well as a second heat transfer space left inside the spiral pipe and confined by an outer shell of said spiral pipe, whereby at least a portion of the container is provided as a pressure vessel. In the invention
the container has its shell provided with at least one, preferably two, openable inspection hatches, at least one inspection hatch having fastened thereto a manifold as well as a shell and tube heat exchanger, preferably a spiral type shell and tube heat exchanger, said shell and tube heat exchanger having its inlet and outlet ends coupled to said manifold which is further provided with means for opening and closing a fluid connection to said shell and tube heat exchanger,
as for its material, the wastewater pipe consists of acid-proof or stainless steel and has its internal surface treated in such a way that, by means of said treatment, the spiral pipe has at least its internal surface adapted to have an average chromium content higher than the average chromium content of other parts of the spiral pipe's wall.

Preferably, said surface treatment is implemented by electrolytic polishing and preferably to a surface roughness below Ra=120.

Preferably, the spiral pipe has also its external surface treated the same way as the internal surface, i.e. the spiral pipe has the average chromium content of its external surface adapted to be higher than the average chromium content of the rest of the spiral pipe's wall (excluding the internal surface). Thus, the spiral pipe's internal surface, and often also the spiral pipe's external surface, is made of steel material whose chromium content exceeds that of the core parts of the spiral pipe's wall. Indeed, it can be said that, when proceeding from the internal surface of the spiral pipe's outer wall towards the core part of the spiral pipe's outer wall, the chromium content becomes lower.

The invention is first of all based on having at least an internal surface of the spiral pipe finished to a low surface roughness and, in addition, having the spiral pipe's internal surface adapted with electrolytic polishing or the like to have an average chromium content higher than in other parts (core parts) of the spiral pipe's wall. Thereby the spiral pipe's internal surface has been enabled to withstand corrosive sewage waters and, in addition, the pipe's walls have been enabled to repel dirt, i.e. have been managed to become self-cleaning. Thirdly in the invention, the container's shell is still provided with one or two openable inspection hatches.

On the other hand, the invention is based on having at least one inspection hatch integrally fitted with a manifold, which has coupled therewith at least one mini-spiral, generally several mini-spirals, which is/are used for conveying for example domestic water or a liquid used in the cooling of a building. Thereby is attained a notable benefit in the sense that the inspection hatch and the manifold integrally coupled therewith, as well as the mini-spirals, facilitate maintenance considerably and improve reliability in maintenance, because the manifold-inspection hatch-mini-spiral combination makes up a single compact entity.

Blending between the domestic water in a pipe left inside the spiral pipe and the blackwater flowing in the spiral pipe is here further prevented by the domestic water and the wastewater traveling in pipelines of their own absolutely separate from each other and having always therebetween a heat transfer fluid flowing in the container's vacant fluid space.

The manifold-inspection hatch-mini-spiral assembly has preferably been proved and pressure tested prior to installing this assembly on the container.

The container is preferably constructed as a shell and tube heat exchanger, whereby the spiral pipe defining a tube side therein and the container shell defining a shell side are constructed as independent pressure vessels which are both dimensioned with distinctive criteria. Because the wastewater to be supplied into the tube side is often at a considerably higher pressure than the heat transfer fluid flowing on the shell side, it is thereby possible to ensure sufficient pressure resistance for the tube side of a shell and tube heat exchanger without having to unnecessarily increase the shell side's wall thickness.

A third important aspect of the invention relates to a heat transfer space confined inside the spiral pipe; in a shell and tube heat exchanger, intended for the treatment of dirty residential and municipal waters, such as black water, this heat transfer space left inside the spiral pipe has fitted therein at least one tube heat exchanger, preferably a spiral tube heat exchanger. The tube heat exchanger has its inlet and outlet ends connected to a manifold and the manifold is integrated with an inspection hatch present in an upper part of the container and the same or different heat transfer fluid can be brought to the manifold from two different directions from outside the container. Thereby is provided a capability of heating/cooling the heat transfer fluid flowing in a shell and tube heat exchanger's shell portion for example with a separate heat exchanger which can be supplied with condensate liquid from a building's cooling or with liquid heated by solar radiation energy.

In one preferred embodiment of the invention, the container has its shell and/or cover provided with one or more flange connections for heat exchangers in order to transfer heat into or out of a heat transfer fluid present in the heat transfer space. Through the flange connections can be extended one or more heat exchangers, such as a building's cooling condensate liquid or solar radiation energy collectors which extend into the heat transfer fluid flowing in the container's heat transfer space.

In one preferred embodiment of the invention, the spiral pipe has an interior which is continuous in view of providing an unobstructed passage for liquid in said spiral pipe. Because the liquid or gas travels without obstruction inside the spiral pipe, there is no need to furnish the container with electrical adjustment elements or valves controlling the passage of liquid or fluid, and the container can be made structurally very simple on the tube side.

In one preferred embodiment of the invention, the spiral pipe has a pitch angle of 0-10 degrees per helix.

Here, the pitch angle of a helix refers to an angle of incidence of the center line of a single helix of the wastewater pipe, i.e. an upward directed helix of the spiral pipe, with respect to a horizontal plane of the spiral pipe, which is transverse to the lengthwise center line of the spiral pipe.

In another preferred embodiment of the invention, it is possible to vary the ratio of a spiral pipe's heat transfer area to the height of a vertical space defined by the spiral pipe's helices.

The height of a vertical space defined by the helices refers to a maximum distance between the highest and lowest helices of a spiral pipe. The spiral pipe's heat transfer area, on the other hand, refers to an aggregate surface area of the spiral pipe's helices.

In yet another preferred embodiment of the invention, the heat transfer rate delivered by the spiral pipe can be adjusted by means of the number of horizontal angles present in the spiral pipe's helices and by the magnitude of said angles.

The horizontal angles of helices or threads refer to flexures or angles in helices, wherein the radius of a helix, measured from the pipe's center line present at the angle, differs from the average radius of the same helix or from the average radius of helices when measured from the lengthwise, i.e. vertical, center line of the spiral pipe.

In another preferred embodiment of the invention, the heat transfer coefficient can be adjusted by means of helical radii of the spiral pipe relative to the vertical center line of the spiral pipe.

The prior art closest to the invention has been presented in patent document DE 102010006882, which nevertheless does not describe an inspection hatch-mounted manifold, nor raising the average chromium content of a spiral pipe's internal surface to become higher than the chromium content in other parts of the spiral pipe's wall.

The invention and benefits attainable therewith will now be described in even more detail with reference to the accompanying figures.

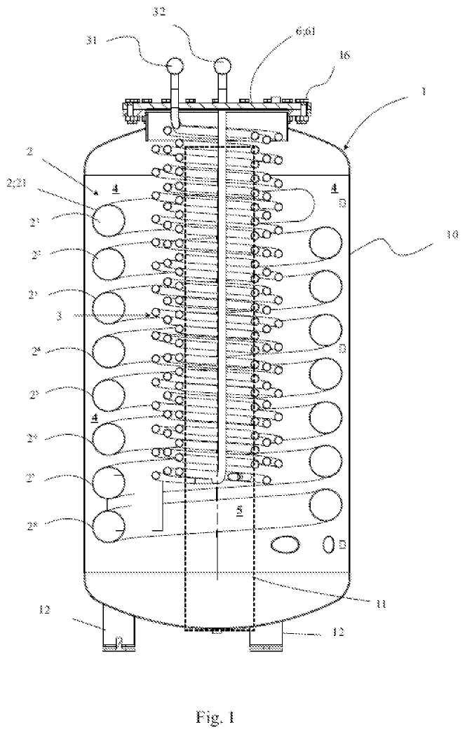

FIG. 1 shows a vertical section view of a container suitable for recovering the heat energy of wastewaters.

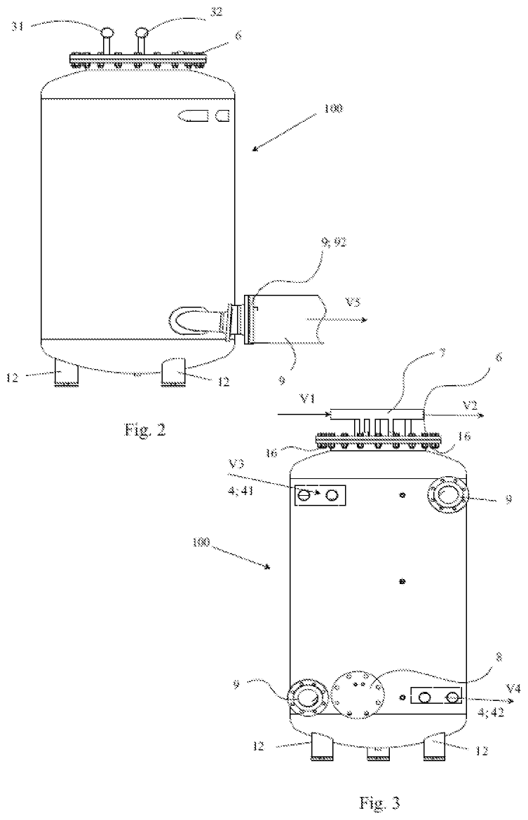

FIGS. 2 and 3 show from slightly different viewing angles the container of FIG. 1 as seen from outside.

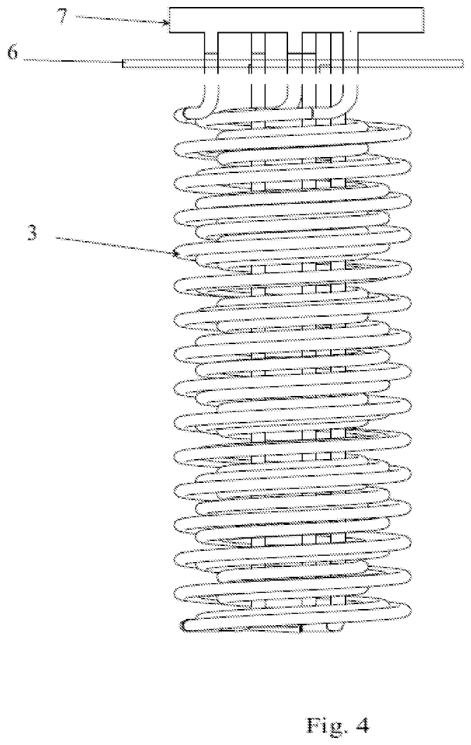

FIG. 4 shows a tube heat exchanger 3, which is in connection with a manifold 7 and coupled with an inspection hatch. This manifold-tube heat exchanger-inspection hatch assembly is also visible in FIG. 1.

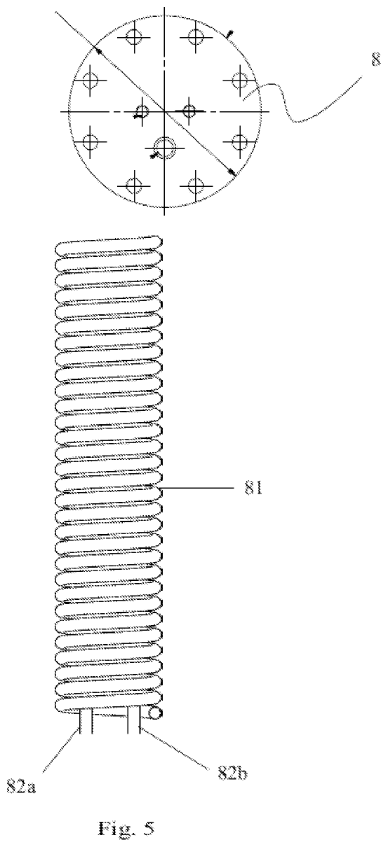

FIG. 5 shows a heat exchanger 81, which is connectable to a flange 8 visible in FIG. 3 at a lower part of the shell of a tube heat exchanger 3, and which here is a spiral solar heat exchanger. The solar heat exchanger's 81 inlet and outlet connections 82a, 82b are connected with a flange joint to a lower part of the tube heat exchanger's 3 shell, or to a heat transfer space 11, which is internal of the tube heat exchanger 3 and thus lies in the interior 11 of these mini-spirals 3.

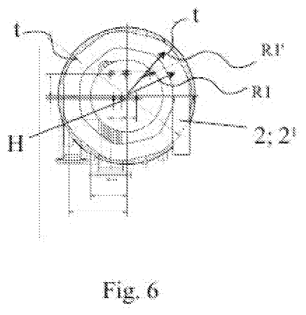

FIG. 6 shows a cross-section of the spiral pipe in a view directly from above.

FIGS. 1-3 depict a first embodiment for a container 1 of the invention, which relates to a container adapted to recovering the energy of residential and municipal wastewaters.

FIG. 1 is a lengthwise section view, showing a container 1 according to a first embodiment of the invention, which functions as a shell and tube heat exchanger especially for the recovery of heat energy from black waters. FIGS. 2 and 3 illustrate how wastewaters and heat transfer liquids are supplied into the container or withdrawn from the container.

As seen from the lengthwise section view of a container 1 shown in FIG. 1, the container functioning as a shell and tube heat exchanger has an outer shell 10 as well as a continuous spiral pipe 2 for conveying wastewater through the container vertically of the container 1. Generally, blackwater travels gravitationally in a top-down direction through the container. The container is equipped with a stand 12.

The spiral pipe 2 constitutes a tube portion of the heat exchanger and is in communication with a wastewater ingress conduit external of the container by way of an inlet connection 2; 21 associated with the container shell (cf. FIG. 3) and with a wastewater egress conduit external of the container by way of an outlet connection 2; 22 associated with the container shell (cf. FIG. 2).

The spiral pipe 2 has its shell, i.e. the spiral pipe's outer wall, directly encircled by a first heat transfer space 4, which at the same time makes up a shell portion for the shell and tube heat exchanger. The first heat transfer space 4 is defined by an outer wall of the spiral pipe 2 and by an outer shell (double shell) of the container 1. This first heat transfer space 4 is in communication with a heat transfer fluid ingress conduit (not shown in the figures) by way of at least one heat transfer fluid inlet connection 4; 41 associated with the shell 10 of the container 1 and with a heat transfer fluid egress conduit (not shown in the figures) by way of at least one heat transfer fluid outlet connection 4; 42 associated with the shell 10 of the container 1. Inside the spiral pipe 2 is left a second heat transfer space 5 , which is thereby located in a vertical space confined by helices 2; 2¹ . . . 2⁸ of the spiral pipe 2. The container 1 is provided as a pressure vessel.

From FIGS. 2 and 3 can be seen in more detail, among others, the construction of the container's 1 shell 10 and the manifold 7 connected to an inspection hatch 6 (a manhole) at an upper part of the container. The upper part of the container's 1 shell 10, visible in FIGS. 2 and 3, is provided with an openable inspection hatch 6, which is fastened with bolts 16 to a collar encircling the container's upper part.

On top of the inspection hatch 6 is integrated or fixedly secured a manifold 7, and this manifold is coupled with a shell and tube heat exchanger as still discretely depicted in FIG. 4. The manifold 7 includes a first valve system or the like, by which can be opened an inlet path for domestic water or a heat transfer fluid to the manifold 7 from two different directions from outside the container. The manifold 7 is further provided with means, such as a second valve system, for opening and closing a fluid connection from said manifold 7 to a spiral type shell and tube heat exchanger 3 located in a second heat transfer space 5 of the container 1. The shell and tube heat exchanger has its inlet and outlet ends 31, 32 connected to said manifold 7. Hence, the shell and tube heat exchanger-manifold-inspection hatch assembly constitutes in itself a removable entity, facilitating container maintenance. Inside the spiral type heat exchanger is left an additional heat transfer space 11, into which can be introduced a separate spiral heat exchanger 81, wherein circulates a heat transfer fluid which is in communication with the recovery of solar radiation energy or with the condensate liquid circulation of a building's cooling system. It can be seen from FIG. 3 how a flow V1 of heat transfer fluid, such as water, arrives at the manifold 7 and further inside the container. The heat transfer fluid passes by way of a spiral type shell and tube heat exchanger present inside the spiral pipe 2 and delivers its thermal energy at the same time into the heat transfer space 5. After this, the heated or cooled liquid flow, such as a water flow V2, discharges from the manifold 7 of the shell and tube heat exchanger 3 and out of the container 1.

It is also seen from FIG. 3 how the first heat transfer space 4, i.e. the heat exchanger's shell portion, is in communication with a heat transfer fluid ingress conduit by way of a heat transfer fluid inlet connection 4; 41 and with an extra-container heat transfer fluid egress conduit by way of a heat transfer fluid outlet connection 4; 42.

The wastewater flow, on the other hand, arrives at an upper part of the container by way of an inlet connection 2; 21 inside the container (cf. FIG. 1). Inside the container, it proceeds along the spiral pipe 2 gravitationally downwards and delivers thermal energy at the same time to the heat transfer fluid present in the shell portion 4. Thereafter, the wastewater discharges from the container by way of a wastewater outlet connection 2; 22.

The material thickness for a wall of the spiral pipe 2 visible in FIG. 1 with respect to an average cross-sectional diameter of the spiral pipe is selected in such a way that the spiral pipe 2 has a maximum pressure resistance level of 10-16 bar. The material thickness for the container's 1 shell 10 with respect to the container's internal diameter is in turn selected in such a way that the container has a maximum pressure resistance level of 4-10 bar. Hence, the spiral pipe in the container's 1 tube portion has a maximum pressure resistance level which is slightly higher than the highest possible pressure resistance level of the container's shell portion.

The material thickness for a wall of the spiral coil 3 visible in FIG. 1 with respect to an average cross-sectional diameter of the spiral pipe is selected, on the other hand, in such a way that the spiral coil 3 has a maximum pressure resistance level of 10-16 bar. Inside the spiral coil 3 can be conveyed domestic water, which is heated by means of a heat transfer fluid traveling in a vacant interior of the container 1, i.e. in the first heat transfer space 4. With regard to its part extending inside the container 1, the spiral coil 3 lies in its entirety in the second heat transfer space 5 and is enveloped from every direction by said heat transfer fluid flowing/present in the container's 1 vacant interior. Consequently, the domestic water traveling in the spiral coil is not at any point in contact with the spiral pipe 2, in which is flowing the dirty blackwater.

Regarding its material, the spiral pipe 2 intended for wastewater and visible in FIG. 1 is made of acid-proof or stainless steel and has its internal surface treated, preferably by electrolytic polishing, to a low surface roughness, for example to below surface roughness Ra=120. In addition, the treatment for an internal surface of the spiral pipe 2 is selected in such a way that, by means of said treatment, the internal surface of the spiral pipe 2 has its average chromium content adapted to be higher than the average chromium content of other wall parts (especially a core part of the wall) of the spiral pipe. The spiral pipe 2 has also its outer surface treated the same way as the internal surface, whereby its average chromium content which is also higher than the average chromium content of other wall parts of the spiral pipe (excluding the spiral pipe's internal surface).

Electrolytic polishing levels electrochemically the microscopically small irregularities on an internal surface of the spiral pipe 2, whereby the dirt does not adhere to the spiral pipe's internal surface as the heat energy is recovered for example from blackwater. On the other hand, increasing the chromium content on an internal surface improves the corrosion resistance of the internal surface. Increasing the chromium content on an outer surface of the spiral pipe deters calcification of the spiral pipe and maintains thermal conductivity (heat penetration) of the spiral pipe at a high level.

As mentioned above, the inspection hatch-manifold-tube heat exchanger 7, 6, 3 make up a single entity, which is easy to lift away all at once, thus facilitating considerably maintenance of the container's 1 interior.

Such an inspection hatch-manifold-tube heat exchanger 7, 6, 3 entity is presented in FIG. 4, but is also visible in FIG. 1.

It is with the section view of FIG. 6 that horizontal angles for helices of the spiral pipe 2 are illustrated. A helix 2¹ of the spiral pipe 2, i.e. a thread of the spiral pipe, has a helical radius R1 outside bends t. The radius is measured as a distance from a vertical center line H of the spiral pipe to the center line of a helix. As opposed to that, at each horizontal angle, i.e. at the bend t, the distance or the radius of curvature is R1′ as measured again as a distance from the vertical center line H of the spiral pipe 2 to the center line of the helix. The helical angles t make an impact on the traveling speed and turbulence of wastewater J in helices 2¹ . . . 2⁸ and therefore on the transfer of heat from liquid flowing inside the spiral pipe 2 to a heat transfer fluid L enveloping the helix 2.

In the foregoing embodiments there are presented just a few implementations for the invention defined in the claims, and it is obvious for a skilled artisan that there are a multitude of other possible implementations for the invention.

### LIST OF REFERENCE NUMERALS (MAIN COMPONENTS)

1 container
2 spiral pipe
21, 22 inlet and outlet connections (for spiral pipe)
3 shell and tube heat exchanger
31,32 inlet and outlet ends (for shell and tube heat exchanger)
4 first heat transfer space
4; 41 heat transfer fluid inlet connection
4; 42 heat transfer fluid outlet connection
5 second heat transfer space
6 inspection hatch
61 top inspection hatch (cover)
7 manifold
8 flange connection
81 spiral heat exchanger
9 wastewater ingress conduit
9; 92 wastewater egress conduit
10 (container's) shell
11 additional heat transfer space inside mini-spiral
12 (container's) stand

1. A container for recovering the heat energy of wastewater, said container comprising a shell defining the container outwards, a continuous spiral pipe for conveying wastewater through the container in vertical direction, said spiral pipe being in communication with an extra-container wastewater ingress conduit by way of an inlet connection associated with the container shell, and with an extra-container wastewater egress conduit by way of an outlet connection associated with the container shell, a first heat transfer space encircling a shell of the spiral pipe and being confined by an outer shell of said spiral pipe and by the shell of the container, and said first heat transfer space being in communication with a heat transfer fluid ingress conduit by way of at least one heat transfer fluid inlet connection associated with the shell of the container and with a heat transfer fluid egress conduit by way of at least one heat transfer fluid outlet connection associated with the shell of the container, as well as a second heat transfer space left inside the spiral pipe and confined by an outer shell of said spiral pipe, whereby at least a portion of the container is provided as a pressure vessel, wherein
the container has its shell provided with at least one, preferably two, operable inspection hatches, at least one inspection hatch having fastened thereto a manifold as well as a shell and tube heat exchanger, preferably a spiral type shell and tube heat exchanger, said shell and tube heat exchanger having its inlet and outlet ends coupled to said manifold which is further provided with means for opening and closing a fluid connection to said shell and tube heat exchanger,
as for its material, the wastewater pipe consists of acid-proof or stainless steel and has at least its internal surface treated in such a way that, by means of said treatment, the spiral pipe has at least its internal surface adapted to have an average chromium content higher than the average chromium content of other parts of the spiral pipe's wall.

2. The container according to claim 1, wherein the spiral pipe has its internal surface, and possibly also its outer surface, treated with electrolytic polishing for reducing its surface roughness.

3. The container according to claim 1, wherein the spiral pipe has both its internal surface and possibly also its outer surface treated with an electrochemical method to a surface roughness below Ra=120.

4. The container according to claim 1, wherein the inspection hatch is coupled to a flange of the container with bolted joints or the like and to the inspection hatch is coupled in an operable manner a shell and tube heat exchanger as well as a manifold.

5. The container according to claim 1, wherein the material thickness of the spiral pipe with respect to an average cross-sectional diameter of the spiral pipe is on the one hand selected in such a way that the spiral pipe has a first pressure resistance level, and the material thickness for the container's shell with respect to the container's internal diameter is on the other hand selected in such a way that the container has a second pressure resistance level, whereby the pressure resistance level of the spiral pipe is different from that of the container.

6. The container according to claim 3, wherein the average cross-sectional diameter of the spiral pipe is selected in such a way that the spiral pipe has on the one hand a pressure resistance consistent with pressure classification 10-16, and the material thickness for the container's shell is on the other hand selected to have its pressure resistance consistent with pressure classification −0.5-6.

7. The container according to claim 1, wherein the second heat transfer space, left inside the spiral pipe, has located therein one or more shell and tube heat exchangers, each having such a ratio of its cross-sectional diameter to the pipe's material thickness that the tubular heat exchanger has a third pressure resistance consistent with pressure classification 10-16.

8. The container according to claim 1, wherein the shell and tube heat exchanger boated in the second heat transfer space is fabricated as an independent pressure vessel from which does not occur any material transfer onto a tube side of the container, i.e. into the spiral pipe, or onto a shell side of the container.

9. The container according to claim 1, wherein the container has the internal and external walls of its shell finished with a treatment enhancing the corrosion and wear resistance thereof.

10. The container according to claim 1, wherein the container has its shell and/or cover and/or bottom provided with one or more additional connections, preferably flange connections, for heat exchangers in order to transfer energy into or out of a heat transfer fluid present in the heat transfer space.

11. The container according to claim 1, wherein the spiral pipe has an interior which is continuous for adapting a liquid to travel in said spiral pipe without obstruction.

12. The container according to claim 1, wherein the spiral pipe has its helices designed to have horizontal angles and/or said helices have a fluctuating radius from a vertical center line of the spiral pipe for changing the flow rate of a liquid flowing inside the spiral pipe.

13. The container according to claim 1, wherein the flow rate of a liquid or gas present inside the spiral pipe is adjusted with wastewater flowing arrangements external of the container.
